(19) United States
(12) Patent Application Publication
(10) Pub. No.: US 2021/0273235 A1
(43) Pub. Date: Sep. 2, 2021

(54) POSITIVE ELECTRODE FOR SOLID-STATE BATTERY, MANUFACTURING METHOD OF POSITIVE ELECTRODE FOR SOLID-STATE BATTERY, AND SOLID-STATE BATTERY

(71) Applicant: HONDA MOTOR CO., LTD., Tokyo (JP)

(72) Inventors: Takuya TANIUCHI, Saitama (JP); Masahiro OHTA, Saitama (JP); Shin IRINO, Saitama (JP)

(21) Appl. No.: 17/261,181

(22) PCT Filed: Jul. 12, 2019
(86) PCT No.: PCT/JP2019/027768

§ 371 Date: Jan. 19, 2021

(30) Foreign Application Priority Data
Jul. 23, 2018 (JP) 2018-137631

(51) Int. Cl. H01M 4/70; H01M 4/04; H01M 4/139; H01M 10/0562; H01M 10/0585; H01M 4/58

(52) U.S. Cl. CPC H01M 4/70; H01M 4/0402; H01M 4/139; H01M 10/0562; H01M 2220/30; H01M 4/5815; H01M 2300/0071; H01M 2220/20; H01M 10/0585

(57) ABSTRACT

A positive electrode for a solid-state battery, a manufacturing method of the positive electrode for the solid-state battery, and the solid-state battery are provided such that the occurrence of cracking during lamination pressing at the time of manufacturing the solid-state battery and short-circuiting due to contact with a tab can be suppressed.

A guide is provided on the outer periphery of a positive electrode active material layer, whereby pressure applied during the lamination pressing is dispersed, and short-circuiting due to contact with a tab is suppressed.

Specifically, the guide is provided on at least two adjoining sides of the outer periphery of the positive electrode active material layer of a surface having the positive electrode active material layer.

### TECHNICAL FIELD

The present invention relates to a positive electrode for a solid-state battery, a manufacturing method of the positive electrode for the solid-state battery, and the solid-state battery.

### BACKGROUND ART

Conventionally, lithium ion secondary batteries have been widely used as secondary batteries having high energy density. A lithium ion secondary battery has a structure where a separator exists between a positive electrode and a negative electrode, and the battery is filled with a liquid electrolyte (an electrolytic solution).

Since the electrolytic solution in the lithium ion secondary battery is normally a flammable organic solvent, safety against heat may be a problem, in particular.

A solid-state battery using, instead of an organic-based liquid electrolyte, an inorganic-based solid electrolyte has been proposed (see Patent Document 1).

Compared with a battery using an electrolytic solution, a solid-state battery using a solid electrolyte makes it possible to solve heat-related problems, and also makes it possible, through lamination, to respond to demands of increased capacity and voltage.

It is also possible to contribute to a compact package.

However, to promote further utilization of solid-state batteries, various types of improvements are still demanded.

Examples of issues that demand improvements include a lamination-positional displacement that occurs during a lamination process at the time of manufacturing, the occurrence of cracking during lamination pressing, and short-circuiting due to contact with a tab.

To satisfy the demands described above, such a method has been proposed in which areas of a positive electrode active material layer, a negative electrode active material layer, and an electrolyte layer are specified to have a certain relation, an electrically insulating member is provided on either the positive electrode active material layer or the negative electrode active material layer, and outer diameters of a positive electrode layer, a negative electrode layer, and the electrolyte layer are made coincident with each other (see Patent Document 2).

However, the method described in Patent Document 2 has not yet solved the risk of short-circuiting due to contact with a tab. Since an active material layer in a solid-state battery is hard and brittle, the occurrence of cracking is still of concern due to restraint at high pressure during lamination pressing.
Patent Document 1: Japanese Unexamined Patent Application, Publication No. 2000-106154
Patent Document 2: Japanese Unexamined Patent Application, Publication No. 2015-125893

### DISCLOSURE OF THE INVENTION

### Problems to be Solved by the Invention

In view of the background art described above, an object of the present invention is to provide a positive electrode for a solid-state battery, a manufacturing method of the positive electrode for the solid-state battery, and the solid-state battery, which makes it possible to suppress the occurrence of cracking during lamination pressing at the time of manufacturing the solid-state battery, and to suppress short-circuiting due to contact with a tab.

### Means for Solving the Problems

To solve the problems described above, the inventors have actively reviewed a method of dispersing pressure during lamination pressing in a laminated body of a solid-state battery.

As a result, it has been found that providing a guide around an outer periphery of a positive electrode active material layer makes it possible to suppress the occurrence of cracking during lamination pressing at the time of manufacturing, and to suppress short-circuiting due to contact with a tab. The present invention has then been completed.

That is, the present invention is a positive electrode for a solid-state battery. The positive electrode includes a positive electrode electric collector, and a positive electrode active material layer that is formed on the positive electrode electric collector and that contains a positive electrode active material. In the positive electrode for the solid-state battery, a positive electrode guide is provided on at least two adjacent sides of an outer periphery portion of the positive electrode active material layer of a surface having the positive electrode active material layer.

The positive electrode guide may be made of an electrically insulating material.

The positive electrode guide may have a thickness indicated by Formula (1) described below.

[Thickness of positive electrode electric collector]≤[Thickness of positive electrode guide]≤[Thickness of positive electrode active material layer]+[Thickness of positive electrode electric collector] (1)

The positive electrode guide may have a thickness indicated by Formula (2) described below.

[Thickness of positive electrode active material layer]−[Thickness of positive electrode electric collector]×½≤[Thickness of positive electrode guide]≤[Thickness of positive electrode active material layer]+[Thickness of positive electrode electric collector]×½ (2)

The positive electrode for the solid-state battery may have a positive electrode tab coupled to the positive electrode electric collector. The positive electrode guide may have a recessed portion allowing the positive electrode tab to protrude from the positive electrode guide.

The recessed portion may have a height indicated by Formula (3) described below.

[Thickness of positive electrode electric collector]×½≤[Height of recessed portion]≤[Thickness of positive electrode guide] (3)

The positive electrode tab may at least partially have a positive electrode tab covering layer made of an electrically insulating material.

In another aspect, the present invention is a manufacturing method of a positive electrode for a solid-state battery. The positive electrode includes a positive electrode electric collector, and a positive electrode active material layer that is formed on the positive electrode electric collector and that contains a positive electrode active material. The manufacturing method of the positive electrode for the solid-state battery includes a positive electrode active material layer forming process of forming a positive electrode active material layer containing a positive electrode active material on the positive electrode electric collector, and a positive electrode guide providing process of providing a positive electrode guide on at least two adjacent sides of an outer periphery portion of the positive electrode active material layer of a surface having the positive electrode active material layer.

In still another aspect, the present invention is a solid-state battery including: a positive electrode for the solid-state battery, including a positive electrode electric collector, and a positive electrode active material layer that is formed on the positive electrode electric collector and that contains a positive electrode active material; a negative electrode for the solid-state battery, including a negative electrode electric collector, and a negative electrode active material layer that is formed on the negative electrode electric collector and that contains a negative electrode active material layer; and a solid electrolyte layer provided between the positive electrode for the solid-state battery and the negative electrode for the solid-state battery. In the solid-state battery, the positive electrode for the solid-state battery is the positive electrode for the solid-state battery described above.

An area of the positive electrode active material layer may be equal to or smaller than an area of the negative electrode active material layer.

The positive electrode guide in the positive electrode for the solid-state battery may have an outer size indicated by Formula (4) described below.

[Outer size of positive electrode guide]≤[Outer size of negative electrode for solid-state battery]+Δ (4)

(In the formula, Δ is, in the solid-state battery, a size of a layer displacement in a laminated body including the positive electrode for the solid-state battery, the negative electrode for the solid-state battery, and the solid electrolyte layer.)

The positive electrode guide in the positive electrode for the solid-state battery may have an inner size indicated by Formula (5) described below.

[Inner size of positive electrode guide]≤[Outer size of positive electrode active material layer+Δ] (5)

(In the formula, Δ is, in the solid-state battery, a size of a layer displacement in a laminated body including the positive electrode for the solid-state battery, the negative electrode for the solid-state battery, and the solid electrolyte layer.)

An area of the positive electrode for the solid-state battery and an area of the negative electrode for the solid-state battery may be substantially identical to each other.

The negative electrode for the solid-state battery may be provided with a negative electrode guide on at least two adjacent sides of an outer periphery portion of the negative electrode active material layer, of a surface having the negative electrode active material layer.

An outer size of the negative electrode guide and the outer size of the positive electrode guide may be substantially identical to each other.

### Effects of the Invention

According to the present invention, it is possible to achieve a solid-state battery that makes it possible to suppress the occurrence of cracking during lamination pressing at the time of manufacturing the solid-state battery, and to suppress short-circuiting due to contact with a tab.

### BRIEF DESCRIPTION OF THE DRAWINGS

FIG. 1 is a top view of a positive electrode for a solid-state battery, according to an embodiment of the present invention;

FIG. 2 is a view illustrating a positive electrode guide according to the embodiment of the present invention;

FIG. 3 is side views of the solid-state battery according to the embodiment of the present invention;

FIG. 4 is a side view of a solid-state battery according to an embodiment of the present invention;

FIG. 5 is a side view of a solid-state battery according to an embodiment of the present invention; and

FIG. 6 is a cross-sectional view of the solid-state battery according to the embodiment of the present invention.

### PREFERRED MODE FOR CARRYING OUT THE INVENTION

Embodiments of the present invention will now be described herein with reference to the accompanying drawings.

However, the embodiments described below merely exemplify the present invention. The present invention is not limited to the below description.

### <Positive Electrode for Solid-State Battery>

A positive electrode for a solid-state battery, according to the present invention, includes a positive electrode electric collector, and a positive electrode active material layer that is formed on the positive electrode electric collector and that contains a positive electrode active material.

The positive electrode for the solid-state battery, according to the present invention, is characterized in that a positive electrode guide is provided on at least two adjacent sides of an outer periphery portion of the positive electrode active material layer of a surface having the positive electrode active material layer.

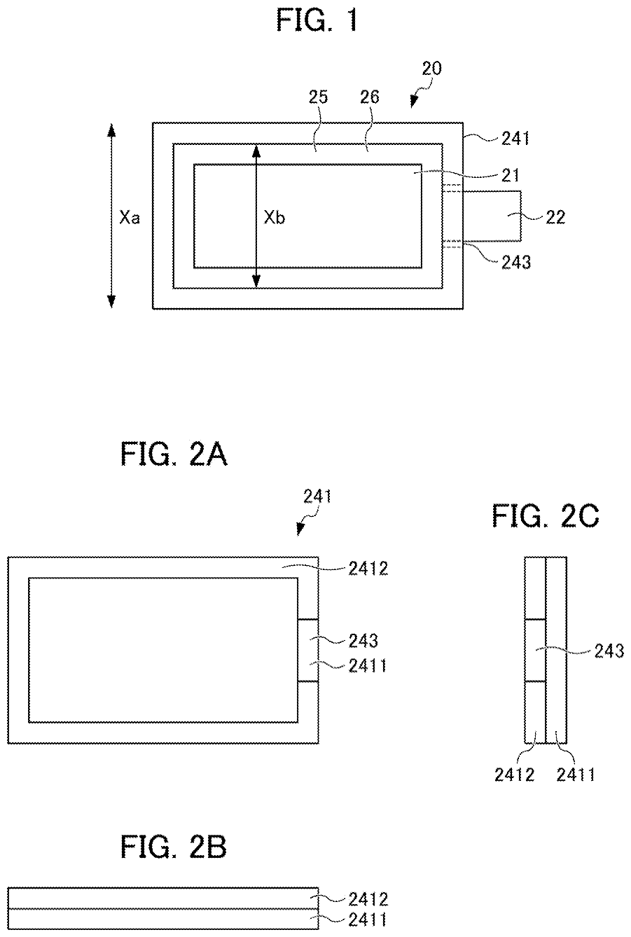

FIG. 1 illustrates the positive electrode for the solid-state battery, according to an embodiment of the present invention.

FIG. 1 is a top view of a positive electrode for a solid-state battery 20.

In the positive electrode for the solid-state battery 20, according to the embodiment, illustrated in FIG. 1, a positive electrode active material layer 21 is formed on a positive electrode electric collector 25.

In the embodiment illustrated in FIG. 1, the positive electrode electric collector 25 has, on all sides (all four sides) around an outer periphery of the positive electrode active material layer 21, a positive electrode active material layer unformed portion 26 where the positive electrode active material layer 21 is not formed. A top positive electrode guide 241 is provided wholly on the positive electrode active material layer unformed portion 26 to surround the positive electrode active material layer 21.

The positive electrode for the solid-state battery 20 further has a positive electrode tab 22 coupled to the positive electrode electric collector 25.

The top positive electrode guide 241 has a recessed portion 243 allowing the positive electrode tab 22 to protrude from the top positive electrode guide 241. The positive electrode tab 22 extends outward of the positive electrode for the solid-state battery 20 via the recessed portion 243.

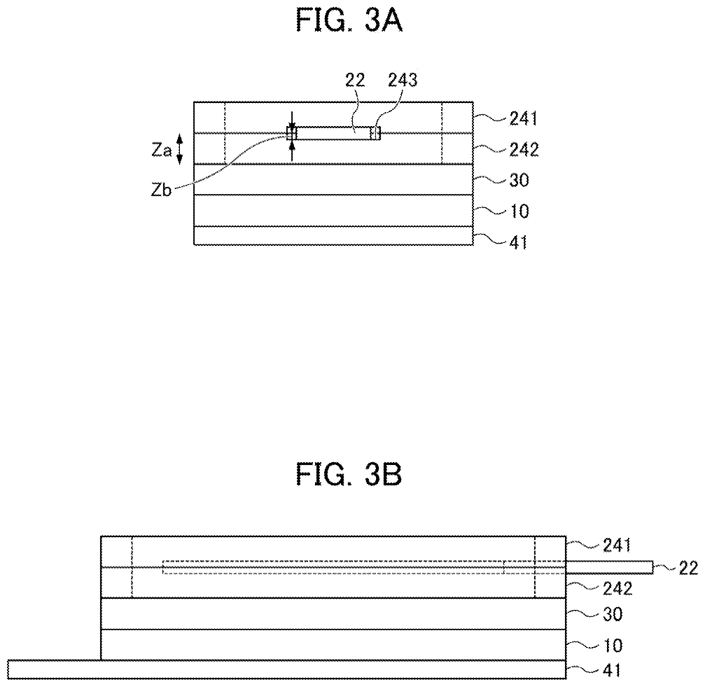

FIG. 3 illustrate side views of the solid-state battery that uses the positive electrode for the solid-state battery, according to the embodiment of the present invention.

FIG. 3(a) is a side view of the solid-state battery, where a surface from which the positive electrode tab 22 protrudes in the positive electrode for the solid-state battery 20, illustrated in FIG. 1, serves as a front surface. FIG. 3(b) is a view illustrating a side surface adjoining the surface illustrated in FIG. 3(a).

In the solid-state battery illustrated in FIG. 3, a negative electrode for solid-state battery 10 is laminated on a support plate 41. On the negative electrode for solid-state battery 10, the positive electrode for the solid-state battery, according to the embodiment of the present invention, is then laminated via a solid electrolyte layer 30.

As two types of positive electrode guides in the positive electrode for the solid-state battery, the top positive electrode guide 241 and an under positive electrode guide 242 exist to serve as layers constituting the positive electrode for the solid-state battery.

In the solid-state battery illustrated in FIG. 3, the top positive electrode guide 241 and the under positive electrode guide 242 respectively have outer sizes and inner sizes each substantially identical to each other, and respectively have, at positions substantially identical to each other, the recessed portions 243 allowing the positive electrode tab 22 to protrude from the positive electrode guides.

When the top positive electrode guide 241 and the under positive electrode guide 242 are laminated with each other, the recessed portions 243 that exist at the positions substantially identical to each other are combined with each other to form an opening portion. Via the opening portion that the two recessed portions 243 form, the positive electrode tab 22 extends outward of the positive electrode for the solid-state battery.

[Positive Electrode Active Material Layer]

The positive electrode for the solid-state battery, according to the present invention, includes, on the positive electrode electric collector, the positive electrode active material layer containing a positive electrode active material.

The positive electrode active material applicable to the present invention is not particularly limited. It is possible to apply a substance that is known to be used as a positive electrode active material layer for a solid-state battery.

Its composition is not also particularly limited. A solid electrolyte, an electrically conductive auxiliary agent, or a binding agent, for example, may be contained.

Examples of the positive electrode active material contained in the positive electrode active material layer according to the present invention include transition metal chalcogenides such as titanium disulfide, molybdenum disulfide, and niobium selenide, and transition metal oxides such as lithium nickel oxide (LiNiO₂), lithium manganese oxide (LiMnO₂, LiMn₂O₄), and lithium cobalt oxide (LiCoO₂).

[Positive Electrode Electric Collector]

An electric collector applicable to the positive electrode for the solid-state battery, according to the present invention, is not particularly limited. It is possible to apply an electric collector that is known to be used for a positive electrode for a solid-state battery.

Examples include metallic foils such as SUS foils and Al foils.

(Positive Electrode Active Material Layer Unformed Portion)

The positive electrode electric collector in the positive electrode for the solid-state battery, according to the present invention, may have the positive electrode active material layer unformed portion, where the positive electrode active material layer is not formed, around the outer periphery portion of the positive electrode active material layer, on the surface having the positive electrode active material layer described above.

The positive electrode active material layer unformed portion, where the positive electrode active material layer does not exist, serves as a portion where the positive electrode electric collector exists as is.

In a case where the positive electrode active material layer unformed portion exists in the solid-state battery, a gap is formed on the positive electrode active material layer unformed portion at a height corresponding to a thickness of the positive electrode active material layer, when the positive electrode for the solid-state battery, the solid electrolyte, and the negative electrode for the solid-state battery are laminated with each other at the time of manufacturing the solid-state battery.

The gap portion serves as a region that may induce the occurrence of cracking during a lamination pressing process after a laminated body is formed.

[Positive Electrode Guide]

The positive electrode for the solid-state battery, according to the present invention, is provided on at least two adjacent sides of the outer periphery portion of the positive electrode active material layer of the surface having the positive electrode active material layer.

In the positive electrode for the solid-state battery 20, illustrated in FIG. 1, the positive electrode active material layer 21 has a rectangular shape. The positive electrode active material layer unformed portion 26 exists on all the four sides, around the outer periphery portion of the positive electrode active material layer 21, of the surface having the positive electrode active material layer 21 on the positive electrode electric collector 25. The top positive electrode guide 241 is provided on the positive electrode active material layer unformed portion 26 on all the four sides to surround the positive electrode active material layer 21.

FIG. 2 illustrates the positive electrode guide according to the embodiment of the present invention.

The positive electrode guide illustrated in FIG. 2 is the top positive electrode guide 241 in the positive electrode for the solid-state battery 20, illustrated in FIG. 1.

The top positive electrode guide 241 illustrated in FIG. 2 has a laminated body structure including two layers, i.e., a top positive electrode guide lower layer 2411 and a top positive electrode guide upper layer 2412.

A region where the layer is discontinuous is formed on the top positive electrode guide upper layer 2412. The discontinuous space forms the recessed portion 243.

The recessed portion 243 serves as a space used when the positive electrode tab is allowed to protrude from the top positive electrode guide 241, making it possible, as illustrated in FIG. 1, for example, to allow the positive electrode tab 22 to extend outward of the positive electrode for the solid-state battery 20 via the recessed portion 243.

In the positive electrode for the solid-state battery, in the solid-state battery, according to the embodiment of the present invention, illustrated in FIG. 3, two types of the positive electrode guides exist, i.e., the top positive electrode guide 241 and the under positive electrode guide 242.

In the positive electrode for the solid-state battery, illustrated in FIG. 3, the top positive electrode guide 241 and the under positive electrode guide 242 respectively have the outer sizes and the inner sizes each substantially identical to each other, and respectively have thicknesses substantially identical to each other. At the positions substantially identical to each other, the recessed portions 243 are provided to allow the positive electrode tab 22 to protrude from the positive electrode guide.

When the top positive electrode guide 241 and the under positive electrode guide 242 are laminated with each other, the recessed portions 243 that exist at the positions substantially identical to each other are combined with each other to form the opening portion. Via the opening portion that the two recessed portions 243 form, the positive electrode tab 22 extends outward of the positive electrode for the solid-state battery.

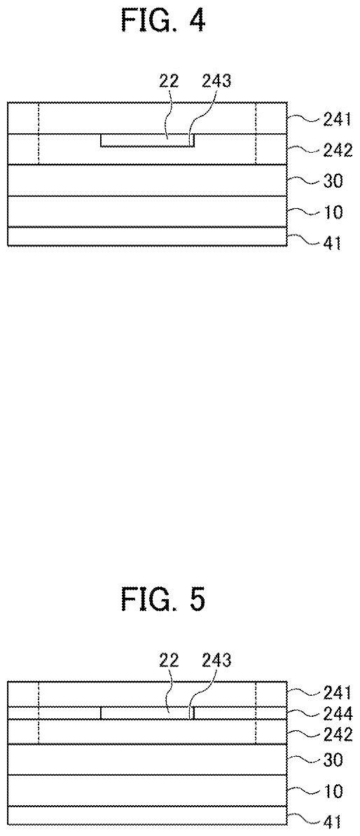

FIGS. 4 and 5 illustrate side views of solid-state batteries that respectively use positive electrodes for the solid-state batteries, according to other embodiments of the present invention.

In the solid-state battery illustrated in FIG. 4, the top positive electrode guide 241 and the under positive electrode guide 242 are combined with each other to constitute the positive electrode for the solid-state battery.

The thickness of the top positive electrode guide 241 is thinner than the thickness of the under positive electrode guide 242. The recessed portion 243 allowing a positive electrode tab to extend is solely formed on the under positive electrode guide 242.

In the solid-state battery illustrated in FIG. 5, a middle positive electrode guide 244 is provided between the top positive electrode guide 241 and the under positive electrode guide 242. The combination of the three types of the positive electrode guides constitutes the positive electrode for the solid-state battery. The top positive electrode guide 241 and the under positive electrode guide 242 respectively have the outer sizes substantially identical to each other, and respectively have the thicknesses substantially identical to each other. No recessed portions are formed on the top positive electrode guide 241 and the under positive electrode guide 242, respectively.

On the other hand, the recessed portion 243 allowing a positive electrode tab to extend is formed on the middle positive electrode guide 244 provided between the top positive electrode guide 241 and the under positive electrode guide 242.

Although an outer size of the middle positive electrode guide 244 is substantially identical to each of the outer sizes of the top positive electrode guide 241 and the under positive electrode guide 242, it is desirable that its thickness be thinner, compared with each of the thicknesses of the top positive electrode guide 241 and the under positive electrode guide 242.

(Arrangement)

The positive electrode guide in the positive electrode for the solid-state battery, according to the present invention, is provided on at least two adjacent sides of the outer periphery portion of the positive electrode active material layer of the surface having the positive electrode active material layer.

The arrangement on at least two sides makes it possible to suppress a laminated body from inclining during a pressing process at the time of manufacturing a solid-state battery, and of using the solid-state battery.

Note that a positive electrode guide may or may not be provided on a positive electrode electric collector, as long as the positive electrode guide is provided on at least two sides around an outer periphery portion of a positive electrode active material layer.

In the present invention, where the positive electrode guide is provided on at least two adjacent sides of the outer periphery portion of the positive electrode active material layer of the surface having the positive electrode active material layer, the positive electrode guide forms a plane to support end portions of a laminated body, even when pressure is applied in a lamination direction to the laminated body at the time of manufacturing a solid-state battery. Therefore, it is possible to suppress the occurrence of cracking during lamination pressing at the time of manufacturing the solid-state battery.

In particular, in a case where a positive electrode active material layer unformed portion is formed on a positive electrode electric collector, similar to the positive electrode for the solid-state battery, according to the embodiment, illustrated in FIG. 2, providing a positive electrode guide around an outer periphery portion of a positive electrode active material layer allows the positive electrode guide to exist in a gap formed on the positive electrode active material layer unformed portion at a height corresponding to a thickness of the positive electrode active material layer at the time of manufacturing the solid-state battery.

The positive electrode guide makes it possible to support the gap portion during a pressing process at the time of manufacturing the solid-state battery, significantly suppressing the occurrence of cracking.

With the positive electrode for the solid-state battery, according to the present invention, where the positive electrode guide is provided around the outer periphery portion of the positive electrode active material layer, it is possible to avoid end portions of the positive electrode electric collector, for example, to be exposed on side surfaces of the laminated body that serves as the solid-state battery.

As a result, at the time of manufacturing the solid-state battery and of using the solid-state battery, for example, the positive electrode guide makes it possible to prevent short-circuiting even when a negative electrode tab coupled to the negative electrode for the solid-state battery comes into contact with the positive electrode for the solid-state battery.

The positive electrode guide provided around the outer periphery portion of the positive electrode active material layer in the positive electrode for the solid-state battery makes it possible to clearly define an external shape of the positive electrode for the solid-state battery, suppressing the occurrence of a lamination-positional displacement at the time of manufacturing.

Note that the positive electrode guide may be at least provided on at least two sides, adjoining the outer periphery portion of the positive electrode active material layer, of the surface having the positive electrode active material layer. The positive electrode guide may be provided on three sides or all four sides.

Particularly, it is most preferable that the guide be provided on all four sides from the viewpoint that it is possible to make an area of the negative electrode and an area of the positive electrode including the guide substantially identical to each other, resulting in that the occurrence of cracking during laminating is further suppressed.

(Shape)

A shape of the positive electrode guide is not particularly limited. It is preferable that the shape be an L shape, when the positive electrode guide is provided on only two adjoining sides the outer periphery portion of the positive electrode active material layer. To provide the positive electrode guide on three sides, it is preferable that the shape be a channel shape. To provide the positive electrode guide on all four sides, it is preferable that the shape be a quadrangular shape, similar to the top positive electrode guide 241 illustrated in FIG. 1.

With an L shape, a channel shape, or a quadrangular shape, the number of parts constituting the positive electrode guide becomes one. It is thus possible to easily provide the positive electrode guide, and to more easily form a plane supporting the laminated body.

Note that, to form the positive electrode guide into a channel shape, it is preferable that its opening portion serves as a part allowing the positive electrode tab to extend.

Therefore, a width of the opening portion in the case of the channel shape is equal to or wider than a width of the positive electrode tab, and is equal to or narrower than a width of the positive electrode active material layer.

(Materials)

It is preferable that the positive electrode guide be made of an electrically insulating material.

With the positive electrode guide to which an electrically insulating property is given, it is possible to prevent short-circuiting even when the negative electrode tab coupled to the negative electrode for the solid-state battery comes into contact with the positive electrode for the solid-state battery.

The electrically insulating material constituting the positive electrode guide is not particularly limited.

It is preferable that the material has an electrically insulating property, and the material does not react with the positive electrode, the negative electrode, and the solid electrolyte. Furthermore, it is particularly preferable that the material has an ion conductive property.

In the present invention, the electrically insulating material may be mixed with another substance. A surface of the positive electrode guide being formed may be applied with a treatment preventing the surface from reacting with the positive electrode, the negative electrode, and the solid electrolyte.

Examples of the electrically insulating material constituting the positive electrode guide include electrically insulating resins such as butyl rubber, polyethylene terephthalate (PET), and silicone rubber, inorganic oxides such as glass, alumina, and ceramic, and cellulose.

When an electrically insulating resin is used to form the positive electrode guide, it is possible to give strength to the positive electrode guide.

When an inorganic oxide is used to form the positive electrode guide, it is possible to give a heat resisting property.

A material constituting the positive electrode guide may be a composite material of the electrically insulating material described above and a solid electrolyte.

For example, the electrically insulating material may be mixed with the solid electrolyte. A surface of the positive electrode guide being formed may be applied with the solid electrolyte for lamination.

The solid electrolyte used to create a composite material is not particularly limited. It is possible to apply an electrolyte constituting the solid-state battery.

Examples include sulfide-based inorganic solid electrolytes, NASICON-type oxide-based inorganic solid electrolytes, and perovskite-type oxide inorganic solid reformed electrolytes.

It is desirable that the positive electrode guide be in firm, close contact with the adjoining solid electrolyte layer. It is thus preferable that the solid electrolyte used to create a composite material be an identical substance to a solid electrolyte used in a solid electrolyte layer constituting a solid-state battery.

(Form)

A form of the positive electrode guide is not particularly limited. For example, as described above, a laminated body may be applied. Embossing may be applied on a surface.

Otherwise, the form of non-woven fabric made of an electrically insulating material may also be applied.

When embossing is applied on a surface, or the form of non-woven fabric is applied, the laminated body including the positive electrode for the solid-state battery, the negative electrode for the solid-state battery, and the solid electrolyte layer is formed at the time of manufacturing the solid-state battery. The embossed portion or a gap in which the non-woven fabric exists is then compressed during lamination pressing, making it possible to achieve a laminated body where the components are in further close contact with each other.

When an electrically insulating resin is used as a material to form the positive electrode guide, it is possible to apply embossing on a surface.

When cellulose is used, it is possible to apply the form of non-woven fabric.

It is preferable that the positive electrode guide used in the present invention be a laminated sheet.

With the laminated sheet, it is possible to use, for outermost layers, respectively, materials that make it possible to improve the adhesion capability to the adjoining solid electrolyte layer and the adjoining positive electrode electric collector during laminating.

It is also possible to select, as an intermediate layer, for example, a material having strength and a function of withstanding heat.

For example, when, as a laminated sheet for a three-layered, laminated body, an intermediate layer is made of a PET resin, and both outer layers are made of a composition of a binder and electrically insulating particles such as alumina particles, it is possible that its anchor effect improves the adhesion capability to the adjoining solid electrolyte layers. It is also possible that its large frictional coefficient suppresses a lateral displacement in the laminated body.

(Thickness)

It is preferable that the positive electrode guide constituting the positive electrode for the solid-state battery, according to the present invention, has a thickness indicated by Formula (1) described below.

[Formula 1]

[Thickness of positive electrode electric collector]≤[Thickness of positive electrode guide]≤[Thickness of positive electrode active material layer]+[Thickness of positive electrode electric collector] (1)

Furthermore, it is preferable that the positive electrode guide has a thickness indicated by Formula (2) described below.

[Formula 2]

[Thickness of positive electrode active material layer]−[Thickness of positive electrode electric collector]×½≤[Thickness of positive electrode guide]≤[Thickness of positive electrode active material layer]+[Thickness of positive electrode electric collector]×½ (2)

Note herein that the thickness of the positive electrode guide means a length, in the lamination direction, of the laminated body that serves as the solid-state battery.

In the positive electrode for the solid-state battery, in the solid-state battery, illustrated in FIG. 3, it is the size indicated by Za, for example.

The positive electrode for the solid-state battery, in the solid-state battery, illustrated in FIG. 3, is the laminated body including two layers, i.e., a layer including the top positive electrode guide 241 and a layer including the under positive electrode guide 242.

Za indicates the thickness of the under positive electrode guide 242.

For example, in the case of the positive electrode for the solid-state battery, illustrated in FIG. 4, the top positive electrode guide 241 and the under positive electrode guide 242 are combined with each other to constitute the positive electrode for the solid-state battery.

The thickness of the top positive electrode guide 241 is thinner than the thickness of the under positive electrode guide 242. The recessed portion 243 allowing the positive electrode tab to extend is solely formed on the under positive electrode guide 242.

To form the positive electrode for the solid-state battery, in the aspect illustrated in FIG. 4, it is desirable that the thickness of the top positive electrode guide 241 be equal to or thicker than the thickness of the positive electrode active material layer. It is also desirable that the thickness of the under positive electrode guide 242 be equal to or thinner than [[Thickness of positive electrode active material layer]+[Thickness of positive electrode electric collector]].

It is then desirable that the total thickness of the thicknesses of the two types of the positive electrode guides be equal to or thinner than [[Thickness of positive electrode active material layer]×2+[Thickness of positive electrode electric collector]].

In the case of the positive electrode for the solid-state battery, illustrated in FIG. 5, the middle positive electrode guide 244 is provided between the top positive electrode guide 241 and the under positive electrode guide 242. The combination of the three types of the positive electrode guides constitutes the positive electrode for the solid-state battery.

The top positive electrode guide 241 and the under positive electrode guide 242 respectively have the thicknesses substantially identical to each other.

The thickness of the middle positive electrode guide 244 is thinner than each of the thicknesses. The recessed portion 243 allowing the positive electrode tab to extend solely exists on the middle positive electrode guide 244.

To form the positive electrode for the solid-state battery, in the aspect illustrated in FIG. 5, it is desirable that the thickness of the middle positive electrode guide 244 fall within a range from a thickness equal to or thicker than the thickness of the positive electrode electric collector to a thickness equal to or thinner than [[Thickness of positive electrode active material layer]×½]. It is then desirable that the total thickness of the thicknesses of all the three types of the positive electrode guides be equal to or thinner than [[Thickness of positive electrode active material layer]×2+[Thickness of positive electrode electric collector]].

In the case of the solid-state battery illustrated in FIG. 3, the top positive electrode guide 241 and the under positive electrode guide 242 are combined with each other to constitute the positive electrode for the solid-state battery.

The top positive electrode guide 241 and the under positive electrode guide 242 respectively have the thicknesses substantially identical to each other, and respectively have, at the positions substantially identical to each other, the recessed portions 243 allowing the positive electrode tab 22 to protrude from the positive electrode guide.

To form the positive electrode for the solid-state battery, in the aspect illustrated in FIG. 3, it is desirable that the thicknesses of the constituent positive electrode guides each satisfy Formula (2) described above.

It is then desirable that the total thickness of the thicknesses of the two types of the positive electrode guides be equal to or thinner than [[Thickness of positive electrode active material layer]×2+[Thickness of positive electrode electric collector]].

In the present invention, the positive electrode guide having the thickness indicated by Formula (1) described above makes it possible to minimize a flatness tolerance and a parallelism tolerance for the positive electrode for the solid-state battery, which is to be acquired. As a result, it is possible to reduce a volume of a multi-layered body, contributing to a high energy property.

With a smaller geometrical tolerance when forming a laminated body, it is possible to evenly apply pressure during lamination pressing at the time of manufacturing, suppressing the occurrence of cracking.

(Recessed Portion)

It is preferable that the positive electrode guide constituting the positive electrode for the solid-state battery, according to the present invention, has a recessed portion serving as a region allowing the positive electrode tab to protrude from the positive electrode guide.

In the positive electrode for the solid-state battery 20, illustrated in FIG. 1, the under positive electrode guide 242 has the recessed portion 243 on its surface.

Via the recessed portion 243, the positive electrode tab 22 extends outward of the positive electrode for the solid-state battery 20.

In the positive electrode for the solid-state battery, constituting the solid-state battery, illustrated in FIG. 3, the top positive electrode guide 241 and the under positive electrode guide 242 respectively have the recessed portions 243 at the positions substantially identical to each other.

The two recessed portions 243 are combined with each other to form the single opening portion. The positive electrode tab 22 passes through the opening portion being formed. The positive electrode tab 22 then extends outward of the positive electrode for the solid-state battery.

It is preferable that the recessed portion on the positive electrode guide has a height indicated by Formula (3) described below.

[Formula 3]

[Thickness of positive electrode electric collector]×½≤[Height of recessed portion]≤[Thickness of positive electrode guide] (3)

The height of the recessed portion on the positive electrode guide is a size of a length in the lamination direction when forming a solid-state battery.

In the solid-state battery using the positive electrode for the solid-state battery, according to the embodiment of the present invention, illustrated in FIG. 3, it is indicated by Zb, and is a size of a length, in the solid-state battery lamination direction, of the recessed portion 243.

When, in the present invention, the recessed portion on the positive electrode guide has the height indicated by Formula (3) described above, the positive electrode tab is free from stress during laminating, making it possible to suppress the occurrence of cracking on tab periphery portions.

[Positive Electrode Tab]

It is preferable that the positive electrode for the solid-state battery, according to the present invention, has a positive electrode tab coupled to the positive electrode electric collector.

The positive electrode tab protrudes from one of the end portions of the positive electrode electric collector, taking a role of coupling the positive electrode electric collector and a positive electrode terminal.

Although its material is not particularly limited, using a material identical to the material of the positive electrode electric collector, for example, makes it possible to perform welding easily and to reduce contact resistance.

Examples of positive electrode tab materials include aluminum and stainless steel. A surface treatment such as nickel plating may be applied, if necessary.

In the positive electrode for the solid-state battery, according to the present invention, it is preferable that the positive electrode guide do not exist in a region allowing the positive electrode tab to extend.

In other words, it is preferable that a gap be formed in a region allowing the positive electrode tab to pass through.

A method of forming the gap is not particularly limited. As an example of the method, a positive electrode guide is formed into a discontinuous shape to allow the subject part to have a cut face, or, as described above, a recessed portion is formed on a surface of a positive electrode guide.

(Positive Electrode Tab Covering Layer)

It is preferable that the positive electrode tab at least partially has a positive electrode tab covering layer made of an electrically insulating material.

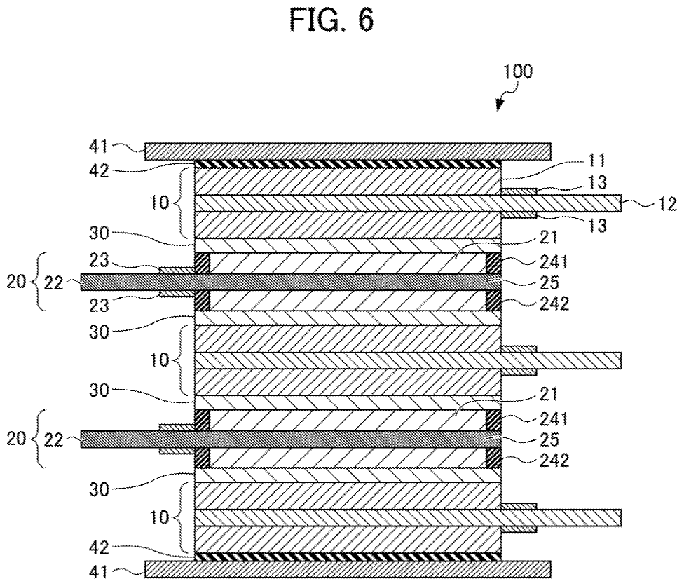

FIG. 6 is a cross-sectional view of the solid-state battery according to the embodiment of the present invention, described later. In a solid-state battery 100 illustrated in FIG. 6, the positive electrode for the solid-state battery 20 that is the positive electrode for the solid-state battery, according to the embodiment of the present invention, partially constitutes the laminated body serving as the solid-state battery 100.

As illustrated in FIG. 6, the positive electrode tab 22 of the positive electrode for the solid-state battery 20 is coupled to the positive electrode electric collector 25. At a part protruded from the positive electrode for the solid-state battery, a positive electrode tab covering layer 23 is provided to cover an outer periphery of the positive electrode tab 22.

With the positive electrode tab having the positive electrode tab covering layer made of an electrically insulating material, it is possible to prevent short-circuiting even when the positive electrode tabs cane into contact with each other at the time of manufacturing the solid-state battery and of using the solid-state battery, for example.

<Manufacturing Method of Positive Electrode for Solid-State Battery>

The manufacturing method of the positive electrode for the solid-state battery, according to the present invention, is not particularly limited. An example of the method includes a positive electrode active material layer forming process of forming a positive electrode active material layer containing a positive electrode active material on a positive electrode electric collector, and a positive electrode guide providing process of providing a positive electrode guide on a region, where no positive electrode active material layer is provided, on the positive electrode electric collector.

Note that the order of executing the positive electrode active material layer forming process and the positive electrode guide providing process is not particularly limited. Either process may be executed first.

[Positive Electrode Active Material Layer Forming Process]

The positive electrode active material layer forming process is a process of forming a positive electrode active material layer containing a positive electrode active material on a positive electrode electric collector.

A method of forming a positive electrode active material layer is not particularly limited.

An example of the method of forming a positive electrode active material layer on a positive electrode electric collector is a wet method.

Through the wet method, a positive electrode mixture containing a positive electrode active material is prepared. The positive electrode mixture is then applied on a positive electrode electric collector and is allowed to dry.

Examples of application methods include a doctor blade method, spray coating, and screen printing.

In the positive electrode active material layer forming process through the wet method, it is preferable that intermittent coating be executed to alternately provide, on the positive electrode electric collector, a part where the positive electrode mixture is applied and a part where the positive electrode mixture is not applied.

With the intermittent coating, it is possible to form a positive electrode active material layer unformed portion between the positive electrode active material layers adjoining each other.

In another method, a positive electrode active material layer formed beforehand is placed on an electric collector.

For example, it is possible that a positive electrode active material layer sheet be cut into a desired size and be placed on a positive electrode electric collector.

With the method, it is possible to form a positive electrode active material layer through the dry method where no liquid is used.

When the positive electrode guide providing process described later is executed first, it is possible to execute another dry method. When the positive electrode guide providing process is executed first, walls of a positive electrode guide are formed on a positive electrode electric collector.

Particles of a positive electrode active material, for example, are filled inside the formed wall to form a positive electrode active material layer.

Even with the method, it is possible to form the positive electrode active material layer where no liquid is used.

Note that, to manufacture a positive electrode for a solid-state battery, a positive electrode active material layer may be formed. The positive electrode active material layer may then be allowed to undergo rolling and/or pressing.

Executing rolling and/or pressing makes it possible to improve a filling ratio of the positive electrode active material, achieving a positive electrode for a large capacity solid-state battery.

[Positive Electrode Guide Providing Process]

The positive electrode guide providing process is a process of providing a positive electrode guide on at least two adjacent sides of an outer periphery portion of a positive electrode active material layer of a surface having the positive electrode active material layer. As described above, a positive electrode guide may be provided before or after the positive electrode active material layer forming process.

In the positive electrode for the solid-state battery, according to the present invention, a part manufactured beforehand, which serves as a positive electrode guide, is placed on a positive electrode electric collector to form the positive electrode guide. Therefore, it is possible to form the positive electrode guide through a dry method.

<Solid-State Battery>

A solid-state battery according to the present invention includes: a positive electrode for the solid-state battery, including a positive electrode electric collector, and a positive electrode active material layer that is formed on the positive electrode electric collector and that contains a positive electrode active material; a negative electrode for the solid-state battery, including a negative electrode electric collector, and a negative electrode active material layer that is formed on the negative electrode electric collector and that contains a negative electrode active material; and a solid electrolyte layer provided between the positive electrode for the solid-state battery and the negative electrode for the solid-state battery. The solid-state battery is characterized in that the positive electrode for the solid-state battery is the positive electrode for the solid-state battery, according to the present invention, described above.

FIG. 6 illustrates the cross-sectional view of the solid-state battery according to the embodiment of the present invention. The solid-state battery 100 illustrated in FIG. 6 has a structure where the negative electrode for solid-state battery 10, the positive electrode for the solid-state battery 20, and the solid electrolyte layer 30 provided therebetween are repeatedly laminated with each other.

An outer side of the negative electrode for solid-state battery 10 provided as an outer side layer in the laminated body is provided with the support plates 41 via electrically insulating films 42.

In the negative electrode for solid-state battery 10, constituting the solid-state battery 100 according to the embodiment, negative electrode active material layers 11 are laminated on both surfaces of the negative electrode electric collector.

A negative electrode tab 12 is coupled to the negative electrode electric collector. At a part protruded from the negative electrode for the solid-state battery, a negative electrode tab covering layer 13 is provided to cover an outer periphery of the negative electrode tab 12.

In the positive electrode for the solid-state battery 20, constituting the solid-state battery 100, the positive electrode active material layers 21 are laminated on both surfaces of the positive electrode electric collector.

The positive electrode tab is coupled to the positive electrode electric collector. At a part protruded from the positive electrode for the solid-state battery, the positive electrode tab covering layer 23 is provided to cover the outer periphery of the positive electrode tab 22.

[Area of Positive Electrode Active Material Layer]

In the solid-state battery according to the present invention, it is preferable that an area of the positive electrode active material layer be equal to or smaller than an area of the negative electrode active material layer.

A case where the area of the negative electrode active material layer is smaller than the area of the positive electrode active material layer is not preferable, because a risk of the occurrence of electro-crystallization of lithium metal on end portions rises.

With the area of the positive electrode active material layer, which is smaller than the area of the negative electrode active material layer, it is possible to improve the durability of a solid-state battery to be acquired.

With the positive electrode for the solid-state battery, according to the present invention, where the positive electrode guide is provided around the outer periphery portion of the positive electrode active material layer, it is possible to exert the effects of the present invention, when the area of the positive electrode active material layer is smaller than the area of the negative electrode active material layer.

[Outer Size of Positive Electrode Guide]

It is preferable that the positive electrode guide in the positive electrode for the solid-state battery has an outer size indicated by Formula (4) described below.

[Outer size of positive electrode guide]≤[Outer size of negative electrode for solid-state battery]+Δ (4)

(In the formula, Δ is, in the solid-state battery, a size of a layer displacement in a laminated body including the positive electrode for the solid-state battery, the negative electrode for the solid-state battery, and the solid electrolyte layer.)

The outer size of positive electrode guide is a size of a maximum width of the guide.

In the present invention, it means each of maximum widths, in both an X axis direction and a Y axis direction, of the positive electrode guide on a plane extending in a direction vertical to the lamination direction of a laminated body that serves as the solid-state battery. That is, the outer size indicated by Formula (4) described above represents either an outer size in the X axis direction or an outer size in the Y axis direction. In the present invention, it is preferable that, the both outer sizes each satisfy Formula (4) described above.

In the positive electrode for the solid-state battery, according to the embodiment of the present invention, illustrated in FIG. 1, the under positive electrode guide 242 is provided, in a quadrangular shape, on all the four sides of the positive electrode active material layer unformed portion 26 on the positive electrode electric collector 25.

In FIG. 1, the outer size, in the X axis direction, of the positive electrode guide is indicated by Xa.

In the present invention, when the positive electrode guide has the outer size indicated by Formula (4) described above, the area of the positive electrode for the solid-state battery, which includes the positive electrode guide, and the area of the negative electrode for the solid-state battery become substantially identical to each other. It is thus possible to further reduce a risk of short-circuiting and to suppress the occurrence of cracking due to stress during laminating.

[Inner Size of Positive Electrode Guide]

It is preferable that the positive electrode guide in the positive electrode for the solid-state battery has an inner size indicated by Formula (5) described below.

[Formula 5]

[Outer size of positive electrode active material layer]≤[Inner size of positive electrode guide]≤[Outer size of positive electrode active material layer+Δ] (5)

(In the formula, Δ is, in the solid-state battery, a size of a layer displacement in a laminated body including the positive electrode for the solid-state battery, the negative electrode for the solid-state battery, and the solid electrolyte layer.)

In the present invention, when the positive electrode guide has the inner size indicated by Formula (5) described above, it is possible that the positive electrode active material layer and the positive electrode guide do not overlap with each other, but be provided on a substantially single plane, suppressing the positive electrode active material layer from cracking.

The inner size of the positive electrode guide is a size of a minimum width of the guide.

In the present invention, it means each of minimum widths, in both the X axis direction and the Y axis direction, of the positive electrode guide on the plane extending in a direction vertical to the lamination direction of the laminated body that serves as the solid-state battery.

That is, the inner size indicated by Formula (5) described above represents either an inner size in the X axis direction or an inner size in the Y axis direction. In the present invention, it is preferable that the both inner sizes each satisfy Formula (5) described above.

In FIG. 1, the inner size, in the X axis direction, of the positive electrode guide is indicated by Xb.

[Area of Positive Electrode for Solid-State Battery]

In the solid-state battery according to the present invention, it is preferable that the area of the positive electrode for the solid-state battery and the area of the negative electrode for the solid-state battery be substantially identical to each other.

With the areas of the positive electrode and the negative electrode, which are substantially identical to each other, it is possible to suppress the occurrence of a positional displacement during a lamination process at the time of forming a solid-state battery. It is also possible, during the lamination pressing process of integrally forming a laminated body, to suppress the occurrence of cracking.

In the present invention, at least the positive electrode for the solid-state battery has the positive electrode guide on at least two adjacent sides of the outer periphery portion of the positive electrode active material layer of the surface having the positive electrode active material layer.

Therefore, controlling the outer size of the positive electrode guide makes it possible to control the area of the positive electrode for the solid-state battery to make the area substantially identical to the area of the negative electrode for the solid-state battery, for example.

Note that, in the solid-state battery according to the present invention, it is preferable that the area of the positive electrode for the solid-state battery, the area of the negative electrode for the solid-state battery, and an area of the solid electrolyte layer be substantially identical to each other.

With the areas of all the layers constituting the laminated body, which are substantially identical to each other, it is possible to further suppress the occurrence of a positional displacement during a lamination process.

It is also possible, during the lamination pressing process, to further suppress the occurrence of cracking.

[Negative Electrode for Solid-State Battery]

The negative electrode for the solid-state battery, which constitutes the solid-state battery according to the present invention, includes a negative electrode electric collector, and a negative electrode active material layer that is formed on the negative electrode electric collector and that contains a negative electrode active material.

(Negative Electrode Active Material Layer)

The negative electrode active material applicable to the negative electrode for the solid-state battery, which constitutes the solid-state battery according to the present invention, is not particularly limited. It is possible to apply a substance that is known to be used as a negative electrode active material layer for a solid-state battery.

Its composition is not also particularly limited. A solid electrolyte, an electrically conductive auxiliary agent, or a binding agent, for example, may be contained.

Examples of the negative electrode active material contained in the negative electrode active material layer according to the present invention include lithium metals, lithium alloys such as Li—Al alloys and Li—In alloys, lithium titanates such as Li₄Ti₅O₁₂, and carbon materials such as carbon fiber and graphite.

(Negative Electrode Electric Collector)

An electric collector applicable to the negative electrode for the solid-state battery, which constitutes the solid-state battery according to the present invention, is not particularly limited. It is possible to apply an electric collector that is known to be used for a negative electrode for a solid-state battery.

Examples include metallic foils such as SUS foils and Cu foils.

(Negative Electrode Active Material Layer Unformed Portion and Negative Electrode Guide)

In the negative electrode for the solid-state battery, which constitutes the solid-state battery according to the present invention, it is preferable that the negative electrode guide be provided on at least two adjacent sides of an outer periphery portion of the negative electrode active material layer of a surface having the negative electrode active material layer.

Providing the negative electrode guide in the negative electrode for the solid-state battery, in addition to the positive electrode for the solid-state battery, makes it possible to further suppress the occurrence of cracking during the lamination pressing process at the time of manufacturing a solid-state battery.

With the negative electrode for the solid-state battery, where the negative electrode guide is provided around the outer periphery portion of the negative electrode active material layer, it is possible to prevent short-circuiting, even when the negative electrode tab coupled to the negative electrode for the solid-state battery comes into contact with the positive electrode for the solid-state battery, at the time of manufacturing a solid-state battery and of using the solid-state battery, for example.

In addition to the positive electrode for the solid-state battery, allowing the negative electrode for the solid-state battery to have the negative electrode guide makes it possible to clearly define an external shape of the negative electrode for the solid-state battery, further suppressing the occurrence of a lamination-positional displacement at the time of manufacturing.

Note that the negative electrode active material layer unformed portion and the negative electrode guide may be respectively similar in configuration to the positive electrode active material layer unformed portion and the positive electrode guide described above.

(Outer Size of Negative Electrode Guide)

When the negative electrode for the solid-state battery, according to the present invention, has a negative electrode guide, it is preferable that its outer size and the outer size of the positive electrode guide described above be substantially identical to each other.

With the outer size of the negative electrode guide and the outer size of the positive electrode guide, which are substantially identical to each other, it is possible to suppress a layer displacement when forming a laminated body at the time of manufacturing a solid-state battery.

[Solid Electrolyte Layer]

For the solid electrolyte layer constituting the solid-state battery according to the present invention, its thickness and shape, for example, are not particularly limited, as long as ionic conduction is possible between the positive electrode for the solid-state battery and the negative electrode for the solid-state battery.

A manufacturing method is not also particularly limited.

A type of the solid electrolyte constituting the solid electrolyte layer is not also particularly limited.

Examples include sulfide-based inorganic solid electrolytes, NASICON-type oxide-based inorganic solid electrolytes, and perovskite-type oxide inorganic solid reformed electrolytes.

The solid electrolyte constituting the solid-state battery according to the present invention contains a binding agent, for example, if necessary.

A compositional ratio of substances contained in the solid electrolyte is not particularly limited, as long as a battery works properly.

[Application of Solid-State Battery]

It is possible that the solid-state battery according to the present invention be formed into a module, for example, for use in various types of devices.

It is possible to preferably use the solid-state battery according to the present invention as a power supply for not only mobile devices, but also electric vehicles and hybrid electric vehicles, for example.

### EXPLANATION OF REFERENCE NUMERALS

100 Solid-state battery
10 Negative electrode for solid-state battery
11 Negative electrode active material layer
12 Negative electrode tab
13 Negative electrode tab covering layer
20 Positive electrode for solid-state battery
21 Positive electrode active material layer
22 Positive electrode tab
23 Positive electrode tab covering layer
241 Top positive electrode guide
2411 Top positive electrode guide lower layer
2412 Top positive electrode guide upper layer
242 Under positive electrode guide
243 Recessed portion
244 Middle positive electrode guide
25 Positive electrode electric collector
26 Positive electrode active material layer unformed portion
30 Solid electrolyte layer
41 Support plate
42 Electrically insulating film
Xa Outer size of positive electrode guide
Xb Inner size of positive electrode guide
Za Thickness of positive electrode guide
Zb Height of recessed portion

1. A positive electrode for a solid-state battery, comprising:
a positive electrode electric collector; and
a positive electrode active material layer formed on the positive electrode electric collector, the positive electrode active material layer containing a positive electrode active material,
wherein a positive electrode guide is provided on at least two adjacent sides of an outer periphery portion of the positive electrode active material layer of a surface having the positive electrode active material layer,
the positive electrode for the solid-state battery has a positive electrode tab coupled to the positive electrode electric collector, and
the positive electrode guide has a recessed portion or an opening portion allowing the positive electrode tab to protrude from the positive electrode guide.

2. The positive electrode for the solid-state battery, according to claim 1, wherein the positive electrode guide is made of an electrically insulating material.

3. The positive electrode for the solid-state battery, according to claim 1, wherein the positive electrode guide has a thickness indicated by Formula (1) described below:
[Formula 1]
[Thickness of positive electrode electric collector]≤[Thickness of positive electrode guide]≤[Thickness of positive electrode active material layer]+[Thickness of positive electrode electric collector] (1).

4. The positive electrode for the solid-state battery, according to claim 1, wherein the positive electrode guide has a thickness indicated by Formula (2) described below:
[Formula 2]
[Thickness of positive electrode active material layer]−[Thickness of positive electrode electric collector]×½≤[Thickness of positive electrode guide]≤[Thickness of positive electrode active material layer]+[Thickness of positive electrode electric collector]×½ (2).

5. (canceled)

6. The positive electrode for the solid-state battery, according to claim 1, wherein the recessed portion has a height indicated by Formula (3) described below:
[Formula 3]
[Thickness of positive electrode electric collector]×½≤[Height of recessed portion]≤[Thickness of positive electrode guide] (3).

7. The positive electrode for the solid-state battery, according to claim 1, wherein the positive electrode tab at least partially has a positive electrode tab covering layer made of an electrically insulating material.

8. A manufacturing method of a positive electrode for a solid-state battery, the positive electrode including a positive electrode electric collector, and a positive electrode active material layer formed on the positive electrode electric collector, the positive electrode active material layer containing a positive electrode active material, the manufacturing method comprising:
a positive electrode active material layer forming process of forming a positive electrode active material layer containing a positive electrode active material on the positive electrode electric collector; and
a positive electrode guide providing process of providing a positive electrode guide having a recessed portion or an opening portion allowing a positive electrode tab to protrude on at least two adjacent sides of an outer periphery portion of the positive electrode active material layer of a surface having the positive electrode active material layer.

9. A solid-state battery comprising:
a positive electrode for the solid-state battery, the positive electrode including a positive electrode electric collector, and a positive electrode active material layer formed on the positive electrode electric collector, the positive electrode active material layer containing a positive electrode active material;
a negative electrode for the solid-state battery, the negative electrode including a negative electrode electric collector, and a negative electrode active material layer formed on the negative electrode electric collector, the negative electrode active material layer containing a negative electrode active material layer; and
a solid electrolyte layer provided between the positive electrode for the solid-state battery and the negative electrode for the solid-state battery,
wherein the positive electrode for the solid-state battery is the positive electrode for the solid-state battery, according to claim 1.

10. The solid-state battery according to claim 9, wherein an area of the positive electrode active material layer is equal to or smaller than an area of the negative electrode active material layer.

11. The solid-state battery according to claim 9, wherein the positive electrode guide in the positive electrode for the solid-state battery has an outer size indicated by Formula (4) described below:
[Formula 4]
[Outer size of positive electrode guide]≤[Outer size of negative electrode for solid-state battery]+Δ (4).
(in the formula, Δ is, in the solid-state battery, a size of a layer displacement in a laminated body including the positive electrode for the solid-state battery, the negative electrode for the solid-state battery, and the solid electrolyte layer.)

12. The solid-state battery according to claim 9, wherein the positive electrode guide in the positive electrode for the solid-state battery has an inner size indicated by Formula (5) described below:
[Formula 5]
[Outer size of positive electrode active material layer]≤[Inner size of positive electrode guide]≤[Outer size of positive electrode active material layer+Δ] (5)
(in the formula, Δ is, in the solid-state battery, a size of a layer displacement in a laminated body including the positive electrode for the solid-state battery, the negative electrode for the solid-state battery, and the solid electrolyte layer.).

13. The solid-state battery according to claim 9, wherein an area of the positive electrode for the solid-state battery and an area of the negative electrode for the solid-state battery are substantially identical to each other.

14. The solid-state battery according to claim 9, wherein the negative electrode for the solid-state battery is provided with a negative electrode guide on at least two adjacent sides of an outer periphery portion of the negative electrode active material layer of a surface having the negative electrode active material layer.

15. The solid-state battery according to claim 14, wherein an outer size of the negative electrode guide and the outer size of the positive electrode guide are substantially identical to each other.
